(19) United States
(12) Patent Application Publication
(10) Pub. No.: US 2011/0191126 A1
(43) Pub. Date: Aug. 4, 2011

(54) EXTERNALLY-MOUNTED APPARATUS AND ASSOCIATED SYSTEMS FOR CONTROLLING VEHICLE ACCESS

(75) Inventors: Robert C. HAMPSHIRE, Pittsburgh, PA (US); Jay SIZEMORE, Franklin, TN (US); Craig A. GAITES, Boston, MA (US)

(73) Assignee: GO-OP, LLC, Boston, MA (US)

(21) Appl. No.: 13/017,804

(22) Filed: Jan. 31, 2011

Related U.S. Application Data
(60) Provisional application No. 61/337,072, filed on Jan. 29, 2010.

(51) Int. Cl. G08B 29/00; G06Q 10/00

(52) U.S. Cl. 705/5; 340/5.54

(57) ABSTRACT

A person-to-person vehicle reservation system for providing distributed access control for a plurality of owner-shared vehicles is disclosed. The system uses access codes managed by an electronic system and for electronically providing access to the plurality of vehicles via smart keys. The system comprises a vehicle database for storing a mapping of vehicles to vehicle access codes; a reservation database for storing a mapping of vehicles to availability information for the vehicles; a reservation request module for receiving reservation requests over a network and for assigning vehicle reservations; and an administrative user module for receiving availability information from administrative users having administrative access to at least one vehicle. The reservation request module is operable to securely transmit a vehicle access code to an electronically-programmable smart key, which provides access to a lockbox holding an ignition key of a vehicle assigned by the reservation request module.

### CROSS-REFERENCE TO RELATED APPLICATIONS

This application claims benefit under 35 U.S.C. §119(e) of U.S. Provisional Application No. 61/337,072, “Externally Mounted Apparatus and Associated Systems for Controlling Vehicle Access,” filed Jan. 29, 2010, which is hereby incorporated by reference in its entirety.

### TECHNICAL FIELD

This disclosure relates generally to motor vehicles, and more specifically to an externally-mounted apparatus and associated systems for controlling vehicle access.

### BACKGROUND

Motor vehicles are typically operated using physical keys, which provide access control to a motor vehicle owner. By providing a key to another individual, the owner can allow the holder of the key to access the vehicle. However, in some cases a motor vehicle owner may desire to provide access to another person while not being able to personally meet the other person to provide him or her with the key. Providing a lockbox which contains the key to the vehicle is one way to do so.

Lockboxes are commonly used by individuals who wish to provide access to their homes when not physically present, and may be used to provide access to vehicles as well. They consist of devices that can be opened by a combination lock and that are secured to a non-moveable object on the premises. However, ordinary lockboxes are not well-suited for use with motor vehicles, as they are not designed to mount to a vehicle. Ordinary lockboxes are also not programmable to provide access using a digital key, such that access may be granted according to rules determined by a computer system.

Lockboxes may be used for person-to-person car sharing, which is a mobility option which allows individuals to pay for the use of vehicles on an as-needed basis through membership programs. Car sharing has been shown to be an effective form of energy demand management because it directly reduces consumption of vehicle travel and therefore consumption of gasoline and diesel fuel. Person-to-person car sharing is a variation on the traditional car sharing model. In the person-to-person model the vehicles are not owned by the business that manages the network, but are instead private vehicles owned by the individuals who participate in the network. Using the person-to-person model, a vehicle-lending network is created that allows car owners to convert their idle vehicles into revenue-generating assets by renting them to other members of the network who need temporary access to vehicle transportation.

### SUMMARY OF THE INVENTION

Systems and methods for providing secure peer-to-peer vehicle sharing are disclosed. In one embodiment, a lockbox for securely holding an ignition key is held in attachment to a vehicle, the lockbox for being mounted on a locked door of a vehicle, the locked door having at least one hem edge for attachment. The lockbox comprises a housing defining an interior chamber to hold the ignition key; a locked entry for allowing access to the interior chamber in an open state and for prohibiting access to the interior chamber in a closed state, the locked entry being responsive to a physical smart key that has been electronically programmed with an access code associated with the lockbox; and an attachment member for providing firm attachment for the lockbox to the vehicle, the attachment member shaped to substantially conform to the hem edge of the vehicle, the attachment member positioning the housing on the exterior of the hem edge, the attachment member positioned on the interior surface of the hem edge where access is restricted by a vehicle lock of the vehicle, and the attachment member not accessible from the exterior of the vehicle, but only accessible when the door of the vehicle is unlocked.

In another embodiment, a person-to-person vehicle reservation system for providing distributed access control for a plurality of owner-shared vehicles is disclosed. The system uses access codes managed by an electronic system and for electronically providing access to the plurality of vehicles via smart keys. The system comprises a vehicle database for storing a mapping of vehicles to vehicle access codes, the vehicle access codes capable of granting access to the vehicles; a reservation database for storing a mapping of vehicles to availability information for the vehicles, the availability information specified by the owners of each of the vehicles, and for storing a mapping of vehicles to vehicle reservations; a reservation request module, in communication with the reservation database, for receiving reservation requests over a network from a requesting user reserving one or more vehicles and for assigning vehicle reservations; and an administrative user module for receiving, over a network, availability information from a plurality of administrative users, the users having administrative access to at least one vehicle, and for aggregating availability information received from the plurality of administrative users, and for accessing the reservation database as the superuser to modify or store availability information for the vehicles. In this system the reservation request module is operable to assigning vehicle reservations to the requesting user, to securely transmit a vehicle access code corresponding to a reserved vehicle to the requesting user for downloading onto an electronically-programmable smart key, the smart key for use in combination with the vehicle access code for granting access to the reserved vehicle, the smart key providing access to a lockbox holding an ignition key of the reserved vehicle during a specified time of the vehicle reservation.

### BRIEF DESCRIPTION OF THE DRAWINGS

In the drawings, FIG. 1 is a schematic overview of a system for vehicle access using a digital smart key and an externally-mounted lockbox.

FIG. 2a is a front isometric view of the externally-mounted lockbox in a closed state.

FIG. 2b is a front isometric view of the externally-mounted lockbox in an open state.

FIG. 3 is an exploded perspective view of the externally-mounted lockbox.

FIG. 4 is an isometric view of sequential states of the externally-mounted lockbox in operation.

FIG. 5 is a back isometric view of the externally-mounted lockbox.

FIG. 6 is a side detail view of a cross section of the mounting mechanism.

FIG. 7a is a cross-section detail view of the mounting mechanism.

FIG. 7b is a cross-section detail view of the mounting mechanism in an alternate embodiment.

FIG. 8 is a schematic diagram showing sequential states of a digital database system prior to allowing access to the lockbox.

FIG. 9 is a schematic diagram showing sequential states of a digital database system subsequent to allowing access to the lockbox.

FIG. 10 is a schematic diagram of a representative physical computing device that may be used for certain embodiments of the disclosed system.

### DETAILED DESCRIPTION

This disclosure pertains to physical lockboxes that provide access to a vehicle by storing a ignition key. A lockbox is disclosed that mounts securely to a motor vehicle while protecting the key to the vehicle within. The disclosed lockbox may be attached to any vehicle without causing damage to the vehicle, and additionally is weatherproof and resistant to physical damage or abuse. The disclosed lockbox does not require physical modifications to the vehicle, or wireless communication with the vehicle to grant access.

In addition, the disclosed lockbox enables securely sharing vehicles between people, i.e. person-to-person car sharing. By providing access to the ignition key, the lockbox provides access to a plurality of drivers. This is additionally facilitated by an remotely programmable electronic smart key and cylinder, which may be programmed to grant access at particular times or to particular drivers.

The disclosure also describes a system for the distributed management of a shared vehicle fleet which is integrated with the above apparatus. The system includes a reservation system and a vehicle access control module. The reservation system controls the access and use of the car, and the return of the car, including billing. Additionally, the reservation system controls access to a fleet of vehicles which can be randomly dispersed throughout a geographic region without need for predefined locations or located at predefined locations. The vehicle control module of the reservation system electronically gives drivers access via a key, or any similar device, to a specific subset of the aforementioned apparatuses mounted on shared vehicles.

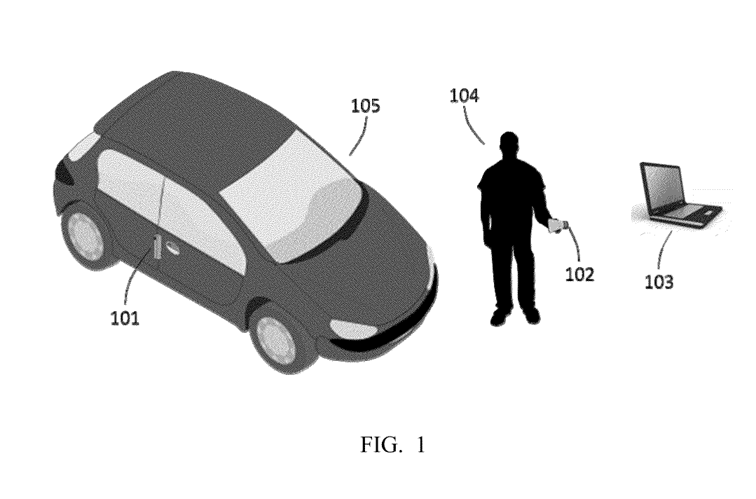

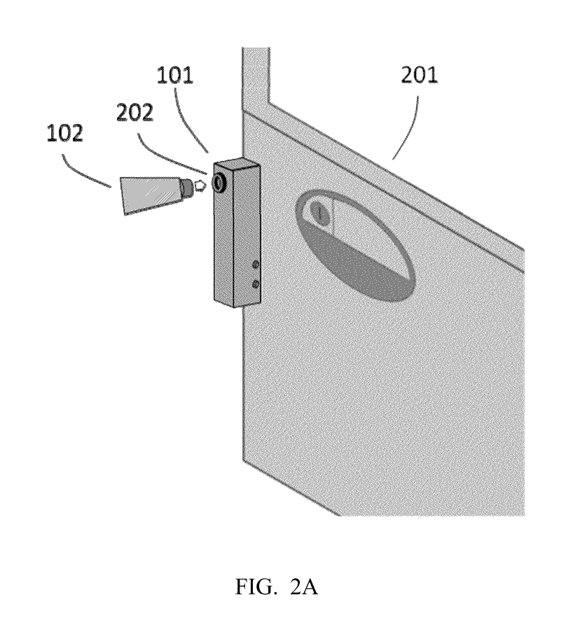

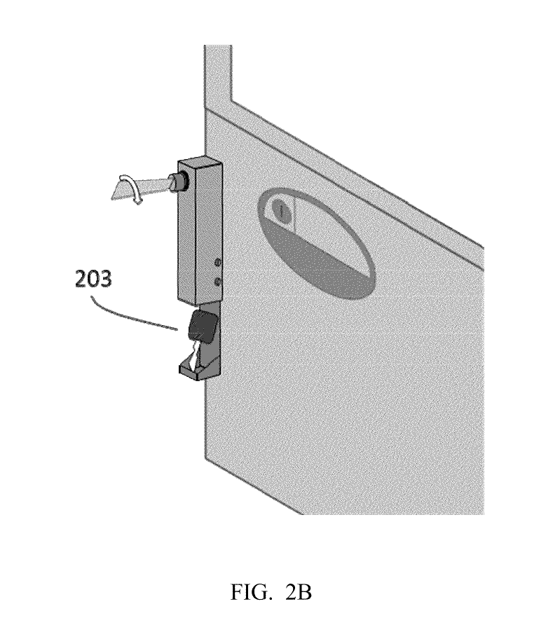

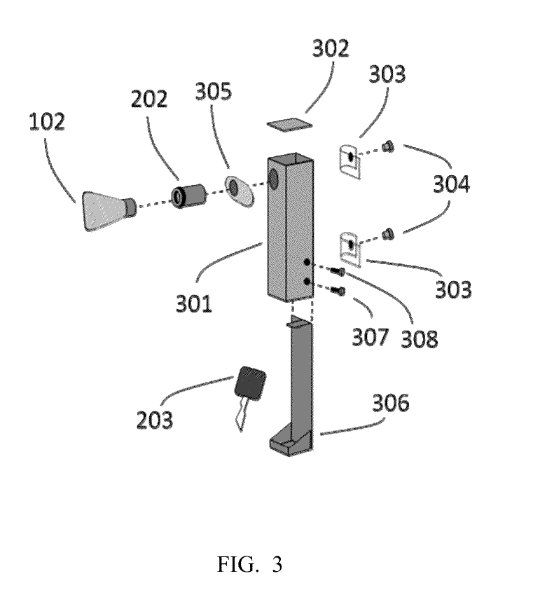

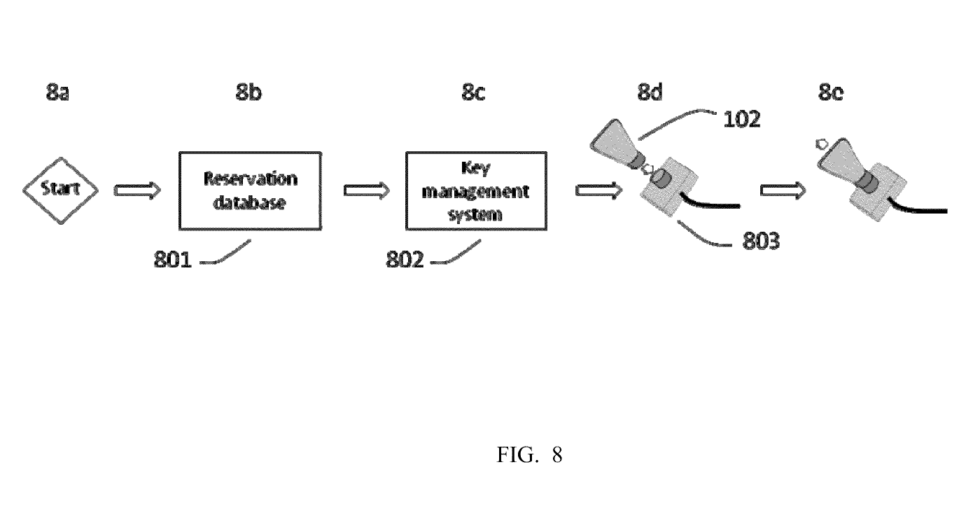

FIG. 1 shows a system for regulating vehicle access using an externally-mounted lockbox 101 according to some embodiments, which securely holds a vehicle's ignition key. A smart key 102 capable of communicating access permissions transmits an access code to an electronic cam-lock key cylinder (shown in FIG. 2) integrated into the externally-mounted lockbox. The access code transmitted to the electronic cam-lock key cylinder is specific to that key cylinder. The access code to the specific key cylinder in the externally-mounted lockbox is downloaded to the smart key from a database (shown in FIG. 8) that can be stored on a server, and shared via the Internet using a computer 103. The components of the system combine to allow a driver 104 to exchange a vehicle's ignition key (shown in FIG. 3) with another driver (not shown) who owns the vehicle 105 without the need to meet in person.

In this application, the term “ignition key” shall be taken to signify any physical means of providing access to a vehicle that is also used in the operation of the vehicle. This shall be taken to include a key fob or wireless access device, or a key for an electric or hybrid electric vehicle, or a key that is used for a vehicle that is not physically inserted to start the vehicle (e.g. when the vehicle is started with a button).

FIG. 2a shows the externally-mounted lockbox 101 in a closed state in accordance with some embodiments. The externally-mounted lockbox is attached to a vehicle closure, which includes a front side door 201, at the front side door's flange or hem edge. In this application, the term “door” shall be taken to signify any part of a vehicle or vehicle closure that opens and is able to be locked, including a trunk, a hood, or any other area of a motor vehicle with a sheet metal hem edge, such that there is an interior and an exterior space covered by a flange. The smart key 102 is paired with an electronic cam-lock key cylinder 202 of the lockbox.

FIG. 2b shows the externally-mounted lockbox in an unlocked and open state in accordance with some embodiments. The externally-mounted lockbox presents a ignition key 203 to the driver.

FIG. 3 shows an exploded view of the externally-mounted lockbox shown in perspective in accordance with some embodiments. Body 301 has varying external dimensions in order to accommodate keys of different sizes, but the preferred approximate dimensions are 6 inches tall by 1.5 inch wide by 1 inch deep. The wall thickness can vary to allow for increased levels of security. The preferred wall thickness is 0.062 inches. The preferred material of the body is corrosion-resistant grade stainless steel to prevent corrosion due to exposure to outdoor climate including rain, snow, heat, chemicals, and dirt. Cap 302 is made from the same thickness of corrosion-resistant grade stainless steel and is welded to the body to seal the internal components from the external environment. A mounting system of the lockbox consists of two C-clamps 303 made of corrosion-resistant grade stainless steel sheet metal, providing water- and weatherproofing, that is bent into shape and welded to the body of the lockbox. The preferred thickness of the C-clamp is 1/16 inch-thick sheet metal. Each C-clamp has a stainless steel weld nut welded to either the inside or outside surface of the C-clamp. Each C-clamp has a machine thread set screw 304 which tightens to the edge of the vehicle closure to which the box is mounted.

The preferred embodiments of the key and key cylinder assembly are off the shelf and consist of smart key 102, key cylinder 202, and cam 305. The preferred specification for the key cylinder and cam would be the Cyberlock CL-C6N manufactured by Videx, Inc. The Cyberlock CL-C6N is an electronic ¾ inch Double-D cam lock. The electronics are encased in a stainless steel core with a stainless steel face and contact pins. The key retaining CL-C6N cam lock has a 1 inch body length and comes with a straight cam. The cam lock is configured to have 90 degree rotation. The preferred specification for the key would be the Cyberkey CK-IR7 manufactured by Videx, Inc. The CyberKey has memory that contains an encrypted access code, a list of locks it may access, schedules of dates and times for accessing locks, and a begin/end date range during which the key will operate. A CyberKey also contains an audit trail of up to 3,900 access events. Each time the key touches a CyberLock, it records the lock ID, date, time, and authorization status. The CK-IR7 key communicates with the key cylinder through the tip of the key. The CK-IR7 key communicates with the database (shown in FIG. 8) when placed in a CyberKey station (shown in FIG. 8), or by making an infrared connection to an IR device (not shown).

In another embodiment, smart key 102 is a smart card, which is read by a smart card reader (not shown). In yet another embodiment, a wireless smart card may be read by a wireless smart card reader.

Drawer 306 is made of corrosion-resistant grade stainless steel sheet metal which is cut, bent and welded into the shape shown. The drawer serves as a chamber for storing the ignition key. The upper tab at the top of the drawer provides the contact interface to the lock cam which prevents and allows downward movement. Not shown in the figure is the detail of the upper tab with gusset or dart near the bend line to provide strength. The bottom of the drawer has a bucket shape to add strength to prevent prying and to hold ignition key 203. Two small machine thread screws 307 and 308 act as guides for the drawer to prevent rotational motion during the sliding function. The uppermost screw also acts as the stopper for the drawer as the upper drawer tab comes to rest on the screw at full extension.

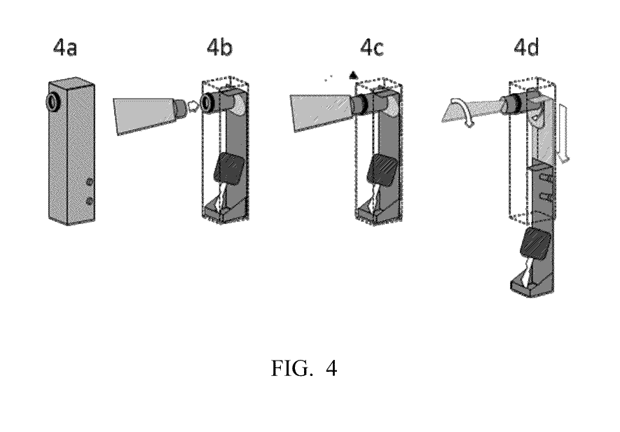

FIG. 4 shows an isometric view of the sequential states of the lockbox function during operation in accordance with some embodiments. View 4a shows the initial state of the lockbox. View 4b is a wireframe view of the initial state. View 4c shows the key being inserted into the key cylinder. View 4d shows the rotation of the key, key cylinder, and cam. The rotation of the cam allows the drawer to slide downward due to gravity. The guide screws shown in FIG. 3, but not shown in views 4a, 4b, or 4c for clarity, are used as a stop and guide for the drawer. To close is the exact opposite function.

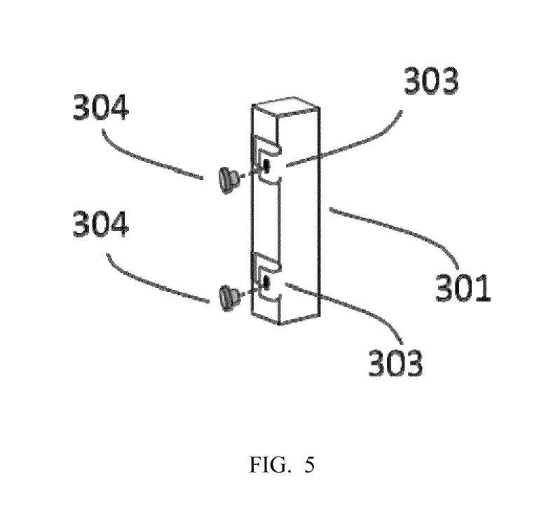

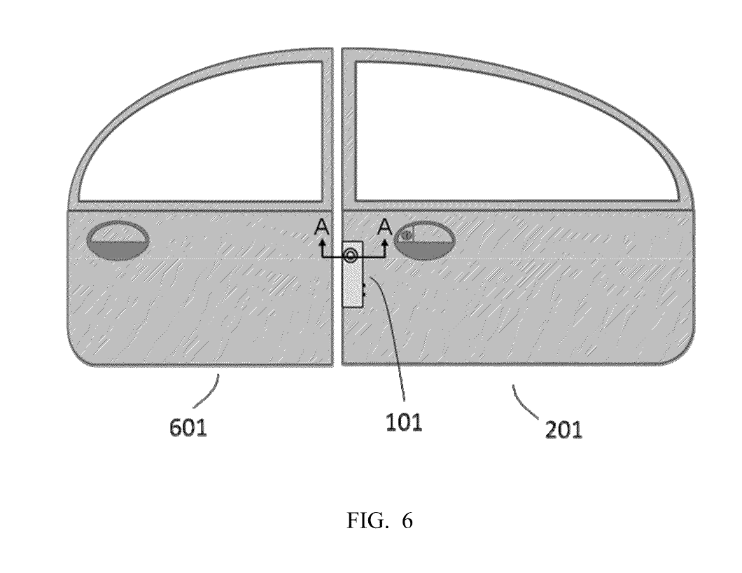

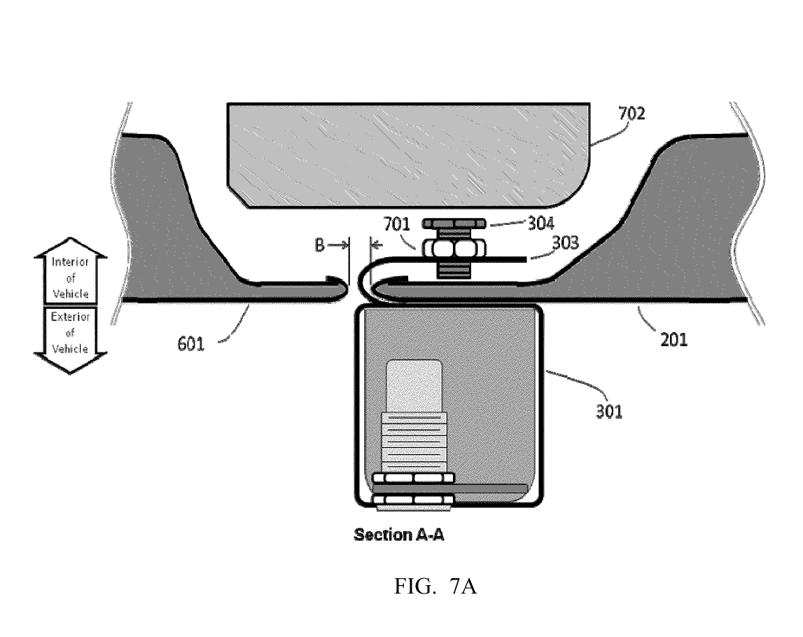

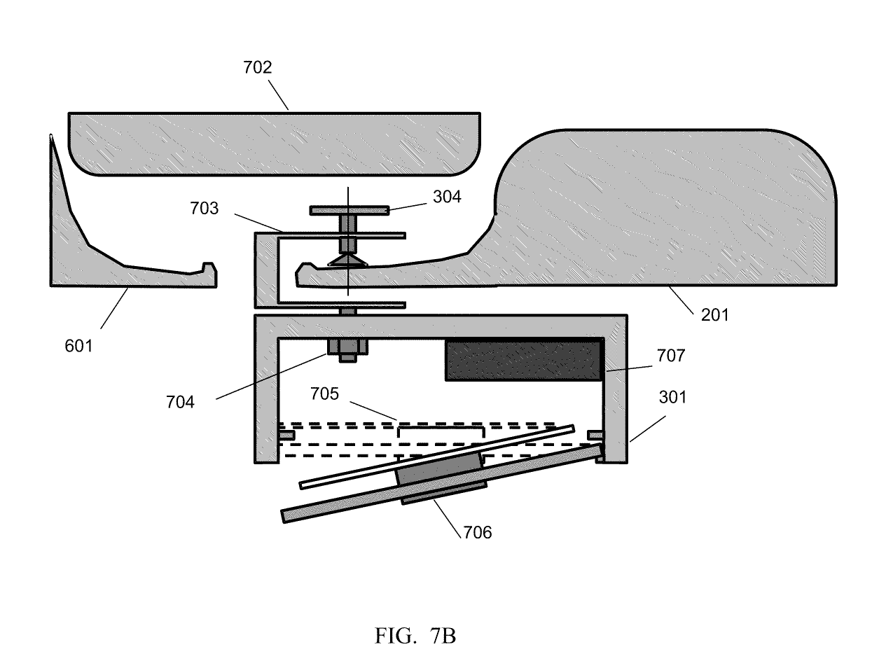

FIG. 5 shows a back isometric view of the external lockbox in perspective in accordance with some embodiments. Body 301 contains the lock mechanism and key holding drawer. Two C-clamps 303 are welded to the body during fabrication. This provides a strong mating to prevent attempted theft of the box by separation of the box from the door. Weld nuts (shown in detail in FIG. 7a) are welded to the C-clamps. These weld nuts provide mate with two set screws 304. These set screws provide the clamping force to the door to prevent the lockbox from sliding along the door's edge. Set screws can be easily tightened and loosened when the vehicle closure is opened. Access to these set screws is extremely limited when the closure is in the closed position which also limits the ability to separate the lockbox from the door. Detail of the C-clamp access in the closed position is shown in FIG. 6 and FIG. 7.

FIG. 6 shows the location of cross section view A-A of external lockbox 101 and the vehicle door closure in accordance with some embodiments. Front side door 201 and rear side door 601, as well as lockbox 101, are shown.

FIG. 7a shows a detailed cross section view A-A taken from the location shown in FIG. 6 in accordance with some embodiments. The detail view of Section A-A is taken from the profile view of the side of the vehicle to show the C-clamp mounting mechanism interface with the front side door 201 and the rear side door 601 at a hem edge. Conventional door closures have such shapes near their edges which is a result of two panels of sheet metal coming together with the outer panel wrapping around the inner panel to form a hem edge, seam or flange. The device can thus be mounted to any hem edge on a vehicle, be it a door edge, trunk edge, body edge or gas door edge, where sufficient clearance is available to accommodate the lockbox. Lockbox C-clamp 303 is mounted at this hem edge. Set screw 304 is tightened to the surface of the inner door panel through weld nut 701. The set screw, weld nut, and C-clamp are sized appropriately to guarantee clearance to the inner structure of the vehicle 702. In addition to holding the lockbox securely on the door, the clamping system also serves as an anchor which cannot be pulled through gap B in the event that a thief tries to forcibly pull the body of the lockbox off of the door by overcoming the clamping force of the set screw.

FIG. 7b shows a detailed cross section view A-A in accordance with an alternate embodiment. The detail view is shown from the side of the vehicle, as in FIG. 7b. Lockbox U-plate 303 is mounted at a hem edge of front side door 201. Also shown is inner structure of vehicle 702 and rear door of vehicle 601. Set screw 304 is tightened through U-plate 703 to the surface of the inner door panel. U-plate 703 is then secured to lockbox body 301 via threaded post 704. Straps, clamps, adhesives, suction, or other clamping devices may also be used either with or without a U-plate or C-clamp to secure the lockbox to the vehicle. Lockbox lid 706, which contains the smart key cylinder, is depicted in an open position. Dotted lines depict the closed position 705 of the lockbox lid. Ignition key 707 is contained within the lockbox cavity.

The remaining figures are representative of the computer- and network-based control systems that are present in some embodiments. In some embodiments, various databases are used, including a vehicle database, a reservation request database, a user database, and an administrative user database. In some embodiments, the system may include a reservation request module, an administrative user module, an authentication module, or a smart key communications module. In some embodiments, glue code or other software may be implemented to allow the various modules to communicate with each other.

FIG. 8 shows a database and associated control systems that store and transmit key cylinder access codes to smart key 102 in sequential states of function during operation prior to accessing a lockbox in accordance with some embodiments. View 8a shows the starting point of the process wherein a driver begins by accessing reservation database 801 using a computer connected to the Internet. The vehicle's owner also independently accesses the reservation database using a computer connected to the Internet. Communicator device 803 may be used to securely transfer the access code to the smart key.

View 8b shows the reservation database's placement in the sequence. The reservation database can be built using any number of off-the-shelf relational database management systems such as Microsoft's SQL Server. The key elements of the reservation database are: 1) a table containing a unique identifier for each vehicle, 2) a table containing a unique identifier for each driver, 3) a table containing a unique identifier for each key, 4) a table containing a unique identifier for each key cylinder, 5) a linking table which can be used for matching each unique vehicle with a unique key cylinder, 6) a linking table which matches each unique driver with a unique key, 6) a table containing a schedule of availability for each vehicle, and 7) a table containing a schedule of reservations for each driver. Various availability information may be stored as an availability schedule, including time of day. Other tables may also be present in some embodiments, including a table containing mappings from each vehicle to the owner of the vehicle.

The driver and the vehicle's owner interact with the reservation database using an Internet-based graphical user interface (GUI). The GUI is built using standard hypertext mark-up language (HTML). Using the GUI the vehicle's owner sets a schedule of availability for the vehicle. Also using the GUI, the driver queries the reservation database for the availability schedule of a specific vehicle, selected by the driver from a list of all vehicles based on its location or other attributes. The driver then selects an appropriate time, based on the driver's individual requirements, from the availability schedule and makes a reservation with an intended start time and intended end time. When a reservation is made, the reservation database records the reservation and removes the time span between the intended start time and the intended end time from the vehicles availability schedule. Finally, the reservation database passes the identifiers for the driver making the reservation, the driver's key, vehicle being reserved, and key cylinder associated with that vehicle to the key management system 802, along with the intended start and end times of the reservation to the key management system.

It is necessary to allow users to administer vehicles that they themselves own, and at the same time to prohibit users from administering vehicles that they do not own. This may be done in some embodiments using a security model or mapping between vehicles and vehicle owners. In some embodiments, the reservation database may be off-limits to all users except a superuser. All modifications to availability schedules initiated by vehicle owners may be aggregated by the system and provided, separately or in a batch, to the reservation database as the superuser.

View 8c shows the key management system's placement in the sequence. The key management system may be an off-the-shelf software product, the preferred embodiment of which is the CyberAudit Web Enterprise package manufactured by Videx, Inc. The CyberAudit package supports a variety of methods for communication between the smart key and the software. A key management system receives the identifiers for the driver making the reservation, the driver's key, vehicle being reserved, and key cylinder associated with that vehicle, along with the start and end times of the reservation from the reservation database. This information is used to update a table of keys stored in a key management system. For each key, the table stores locks that each key may access, schedules of dates and times for accessing locks, and a begin/end date range during which the key will operate. Key software also stores and updates tables containing unique identifiers for each vehicle, each driver, and specific keys and cylinders associated with them.

View 8d shows a communicator device 803 connected to a driver's computer (not shown) communicating with the key management system via the Internet. Once the key management system has been fully updated it is capable of communicating, for each key, a line from its key table that describes the locks that that key may access, schedules of dates and times for accessing locks, and a begin/end date range during which the key will operate, along with an access code to the lockbox attached to a reserved vehicle associated with that key in the key management system. There are several potential embodiments of the communicator device, which can be any device with an infrared (IR) port or any of the CyberKey stations manufactured by Videx, Inc. The preferred embodiment of the communicator device is the CyberKey USB station.

View 8e shows a driver inserting a smart key into a communicator device to download, for that driver's key, a line from key management system's key table that describes the locks that the key may access, schedules of dates and times for accessing locks, and a begin/end date range during which the key will operate, along with an access code to the lockbox attached to the reserved vehicle associated with that key in the key management system. Once a reservation has downloaded to the key via the communicator device, the driver removes the key from the device and proceeds to the vehicle, operating the key and lockbox as shown in FIG. 4.

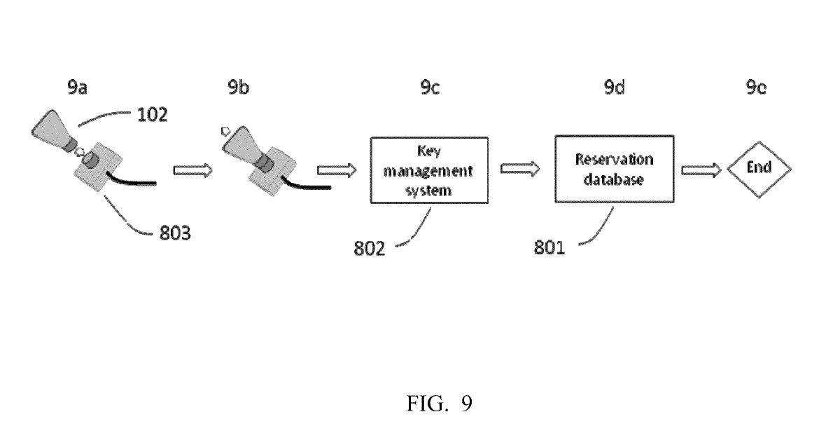

FIG. 9 shows a driver returning smart key 102 to communicator device 803 after accessing the lockbox mounted to the reserved vehicle in accordance with some embodiments. When the driver first accesses the vehicle by inserting the key into the lockbox and operating it as shown in FIG. 4, the key logs the event into its memory as the start time of the reservation. Similarly, when the driver is finished using the vehicle and returns the key to the lockbox by performing the opposite of the operation shown in FIG. 4, the key also logs that event into its memory as the actual end time of the reservation. View 9a shows the driver returning the key to the communicator device. When the driver performs this operation the log stored in the key is uploaded back to communicator device. View 9b shows the communicator device communicating with the key management system via the internet. The communicator device transmits the log uploaded from the key back to the key management system. View 9c shows the key management system transmitting the uploaded data to the reservation database. View 9d shows the actual reservation database receiving the uploaded log from the key management system. Once the reservation database has received the uploaded log, it then stores the actual start and end times for that reservation. The actual start and end times can later be compared to the intended start and end times to verify that the driver accessed the lockbox during the intended reservation period.

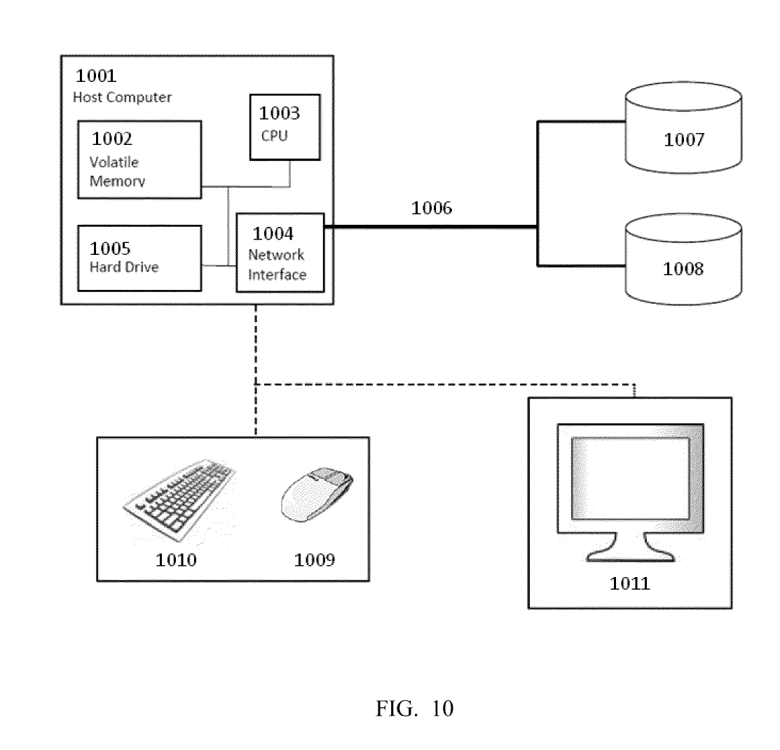

FIG. 10 is a diagram that depicts a representative component of a computerized system upon which certain elements may be implemented, according to certain embodiments of the disclosure. The logical modules described may be implemented on host computer 1001 that contains volatile memory 1002, a persistent storage device such as hard drive 1005, processor 1003 and network interface 1004. Using the network interface, the system computer can interact with databases 1007, 1008 over network 1006, among other embodiments. In some embodiments, network 1006 may be the Internet. Although FIG. 10 illustrates a system in which the system computer is separate from the various databases, some or all of the storage may be housed within the host computer, eliminating the need for a network interface. The programmatic processes may be executed on a single host, as shown in FIG. 10, or they may be distributed across multiple hosts, or they may be distributed across a network such as the Internet.

The host computer shown in FIG. 10 may serve as an administrative workstation, or may implement a web-based vehicle reservation user interface which communicates with the key management system or the reservation database, or may implement any and all logical modules described in this specification. Host computers may be connected to a graphical display device, 1007, and to input devices such as mouse 1009 and keyboard 1010. Alternately, the active user's workstation may comprise a handheld device, such as a cellular phone, mobile computer or tablet computer.

Throughout this specification we refer to software components, but all references to software components are intended to apply to software running on hardware such as the computer systems described in FIG. 10. Likewise, objects and data structures referred to in the specification are intended to apply to data structures actually stored in memory, either volatile or non-volatile.

The foregoing has outlined some of the more pertinent features of the subject matter. These features should be construed as being merely illustrative. Many other beneficial results can be attained by applying the disclosed subject matter in a different manner or by modifying the subject matter as will be described.

We claim:

1. A lockbox for securely holding an ignition key held in attachment to a vehicle, the lockbox for being mounted on a locked door of a vehicle, the locked door having at least one hem edge for attachment, the lockbox comprising:
a housing defining an interior chamber to hold the ignition key;
a locked entry for allowing access to the interior chamber in an open state and for prohibiting access to the interior chamber in a closed state, the locked entry being responsive to a physical smart key that has been electronically programmed with an access code associated with the lockbox; and
an attachment member for providing firm attachment for the lockbox to the vehicle, the attachment member shaped to substantially conform to the hem edge of the vehicle, the attachment member positioning the housing on the exterior of the hem edge, the attachment member positioned on the interior surface of the hem edge where access is restricted by a vehicle lock of the vehicle, and the attachment member not accessible from the exterior of the vehicle, but only accessible when the door of the vehicle is unlocked.

2. The lockbox of claim 1, wherein the locked entry includes a digital key cylinder for receiving the smart key, the digital key cylinder including a memory capable of storing the access code.

3. The lockbox of claim 2, wherein the digital key cylinder includes a rotatable cam, and wherein the lockbox includes a drawer defining the interior chamber, wherein the rotation of the rotatable cam releases the drawer.

4. The lockbox of claim 1, wherein the smart key is a smart card and wherein the locked entry includes a smart card reader.

5. The lockbox of claim 1, wherein the smart key makes physical contact with the locked entry.

6. The lockbox of claim 1, wherein the smart key may be programmed more than once and given different access codes.

7. The lockbox of claim 1, wherein the lockbox is detachably mounted to the vehicle without permanently modifying the vehicle.

8. The lockbox of claim 1, wherein the lockbox has a center of inertia near the point of attachment of the attachment member to the housing, so that it is difficult to use a lever to remove the lockbox from the exterior of the vehicle.

9. The lockbox of claim 1, wherein the attachment member includes a c-clamp.

10. The lockbox of claim 1, wherein the attachment member includes set screws.

11. A person-to-person vehicle reservation system for providing distributed access control for a plurality of owner-shared vehicles using access codes managed by an electronic system and for electronically providing access to the plurality of vehicles via smart keys, the system comprising:
a vehicle database for storing a mapping of vehicles to vehicle access codes, the vehicle access codes capable of granting access to the vehicles;
a reservation database for storing a mapping of vehicles to availability information for the vehicles, and for storing a mapping of vehicles to vehicle reservations;
a reservation request module, in communication with the reservation database, for receiving reservation requests over a network from a requesting user reserving one or more vehicles; and
an administrative user module for receiving, over a network, the availability information from a plurality of administrative users, each administrative user having administrative access to at least one vehicle owned by that administrative user, and for aggregating availability information received from the plurality of administrative users, and for accessing the reservation database as the superuser to modify or store availability information for the vehicles,
wherein the reservation request module is operable to assigning vehicle reservations to the requesting user, to securely transmit a vehicle access code corresponding to a reserved vehicle to the requesting user for downloading onto an electronically-programmable smart key, the smart key for use in combination with the vehicle access code for granting access to the reserved vehicle, the smart key providing access to a lockbox holding an ignition key of the reserved vehicle during a specified time of the vehicle reservation.

12. The vehicle reservation system of claim 11, wherein the administrative user module is operable to reject availability information for a vehicle if the availability information is received from a user without administrative access to the vehicle.

13. The vehicle reservation system of claim 11, wherein the administrative users are not granted administrative access to the reservation database.

14. The vehicle reservation system of claim 11, wherein the vehicle reservation system is operable to securely transmit availability information to the electronically-programmable smart key for providing access control to the lockbox according to the availability information.

15. The vehicle reservation system of claim 11, wherein the availability information is based on time of day.

16. The vehicle reservation system of claim 11, wherein the plurality of owner-shared vehicles includes a fleet of vehicles, and wherein the plurality of administrative users include a fleet operator.
